(19) United States
(12) Patent Application Publication
(10) Pub. No.: US 2008/0265550 A1
(43) Pub. Date: Oct. 30, 2008

(54) Airbag module

(75) Inventors: Jason Carl Lisseman, Shelby Township, MI (US); Kenneth Irving Beaty, Lake Orion, MI (US); Danielle Marie Lipson, Royal Oak, MI (US); Angela Susan Schneider, Waterford, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/081,779

(22) Filed: Apr. 21, 2008

Related U.S. Application Data
(60) Provisional application No. 60/907,978, filed on Apr. 25, 2007.

(51) Int. Cl. B60R 21/16

(52) U.S. Cl. 280/728.2

(57) ABSTRACT

An airbag module comprises an airbag cushion, a cover, an inflator to inflate the airbag cushion, a retaining ring, and an integrated one-piece retainer and diffuser component. The integrated retainer and diffuser component couples to the cover to form a space for the airbag cushion in the airbag module. The integrated retainer and diffuser component disperses inflation gas from the inflator into the airbag cushion. The integrated retainer and diffuser component comprises a glass filled plastic material.

### CROSS-REFERENCE TO RELATED PATENT APPLICATIONS

This application claims priority to U.S. Provisional Application No. 60/907,978, filed Apr. 25, 2007, which is incorporated herein by reference in its entirety.

### FIELD

The present disclosure relates generally to the field of airbags. More specifically, the disclosure relates to a diffuser and a retainer for a steering wheel airbag module that are formed from a glass-polymer composite.

### BACKGROUND

It is known to provide inflatable airbags in a vehicle. Inflatable airbags are inflated by gas directed into the airbag in response to a vehicle experiencing a sudden deceleration above a predetermined threshold or in response to other factors. The inflated airbag absorbs energy resulting from the movement of an occupant within the vehicle compartment against the airbag. The energy absorbed by the airbag is dissipated to minimize rebounding of the occupant from the airbag. Airbags may be provided at a variety of places within the vehicle to protect an occupant of the vehicle in a variety of impact scenarios. For example, airbags may be provided in the dashboard, proximate to the steering wheel, in the vehicle seats, in the door trim panels, in the headliner, etc. The steering wheel airbag assembly generally includes an inflator, an airbag that is inflated by the inflator, a diffuser, and a retainer that mechanically couples the airbag assembly to the vehicle, such as with threaded studs.

It would be desirable to provide an airbag assembly that is less expensive and easier to assemble.

### SUMMARY

One exemplary embodiment relates to an airbag retainer integrally combined with a diffuser, the integrated retainer and diffuser being one piece and comprising glass filled plastic.

Another embodiment relates to an airbag module, comprising an airbag cushion; a cover; an inflator to inflate the airbag cushion; and an integrated one-piece retainer and diffuser component. The integrated retainer and diffuser component couples to the cover to form a space for the airbag cushion. The integrated retainer and diffuser component disperses inflation gas from the inflator into the airbag cushion. The airbag module further includes a retaining ring to couple the airbag cushion to the integrated retainer and diffuser component.

### BRIEF DESCRIPTION OF THE DRAWINGS

FIG. 1 is an isometric view of a vehicle including an airbag module according to an exemplary embodiment.

FIG. 2 is a cross section of a portion of a steering column for a vehicle showing an airbag assembly according to one exemplary embodiment.

FIG. 3 is a front isometric view of the airbag assembly of FIG. 2 according to an exemplary embodiment with the airbag cushion removed for clarity.

FIG. 4 is a rear isometric view of the airbag assembly of FIG. 2 according to an exemplary embodiment with the airbag cushion removed for clarity.

FIG. 5 is a front view of the one-piece retainer and diffuser of FIG. 3 according to an exemplary embodiment.

FIG. 6 is a side view of the one-piece retainer and diffuser of FIG. 3 according to an exemplary embodiment.

FIG. 7 is a rear view of the one-piece retainer and diffuser of FIG. 3 according to an exemplary embodiment.

FIG. 8 is a cross section of an airbag assembly according to an exemplary prior art embodiment.

### DETAILED DESCRIPTION

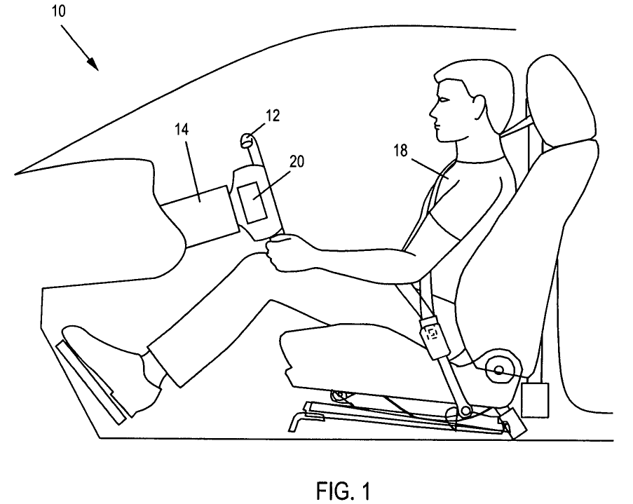

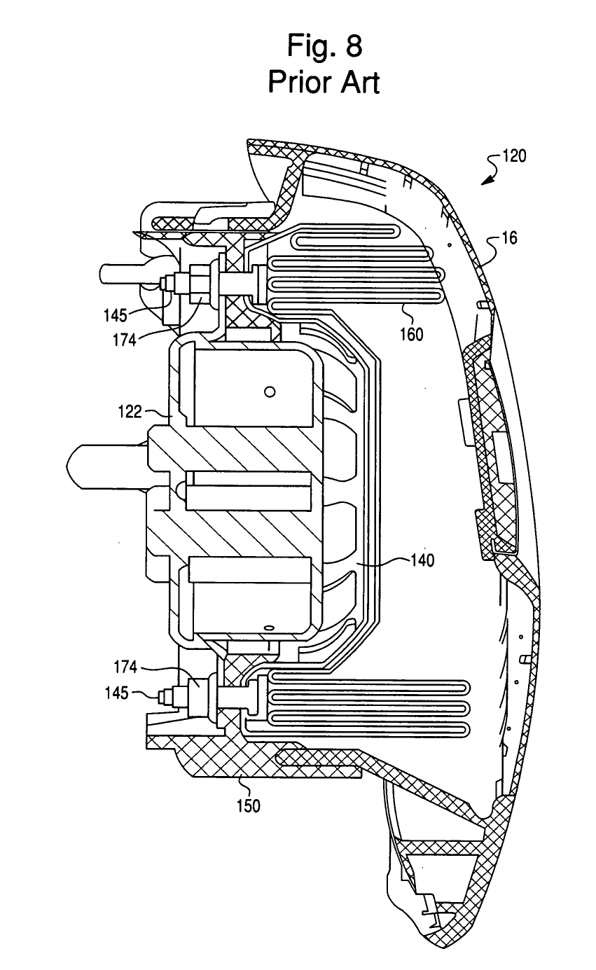

Referring to FIG. 1, a vehicle 10 is shown according to an exemplary embodiment. The vehicle 10 includes one or more seats that are configured to receive an occupant 18 and are coupled to the vehicle. Airbags may be provided at a variety of places within the vehicle 10 to protect an occupant 18 of the vehicle in a variety of impact scenarios. For example, airbags may be provided in the dashboard, proximate to the steering wheel 12, in the vehicle seats, in the door trim panels, in the headliner, etc. According to an exemplary embodiment, a steering wheel airbag assembly 20 is coupled to the steering column 14. As an inflating gas enters the airbag cushion, the airbag cushion bursts through an outer skin or cover 16 (FIG. 8) and inflates between the driver 18 of the vehicle and the steering wheel 12.

A conventional retainer 150 and diffuser 140 are two separate components that are fixed together, such as shown in FIG. 8. The conventional airbag assembly 120 of FIG. 8 includes an inflator 122, a diffuser 140, a retainer 150, and an airbag (sometimes referred to as a “cushion”) 160. Airbag cushion 160 is generally formed from a multitude of panels of a fabric such as nylon. Inflator 122 generates a gas that rapidly inflates the airbag in an impact or vehicle collision. Diffuser 140 is provided between the inflator 122 and the airbag 160. Diffuser 140 is a thin-walled member formed from, for example, a steel material. Diffuser 140 includes mounting studs 145 that are received by openings in retainer 150 and openings in inflator 122. Retainer 150 is generally formed from a plastic material. The edges of the airbag are trapped between diffuser 140 and retainer 150. Nuts 174 are threaded onto studs 145 to couple retainer 150 to inflator 122, airbag 160, and diffuser 140. The entire airbag assembly 120 is then bolted to a structural portion of the vehicle 10.

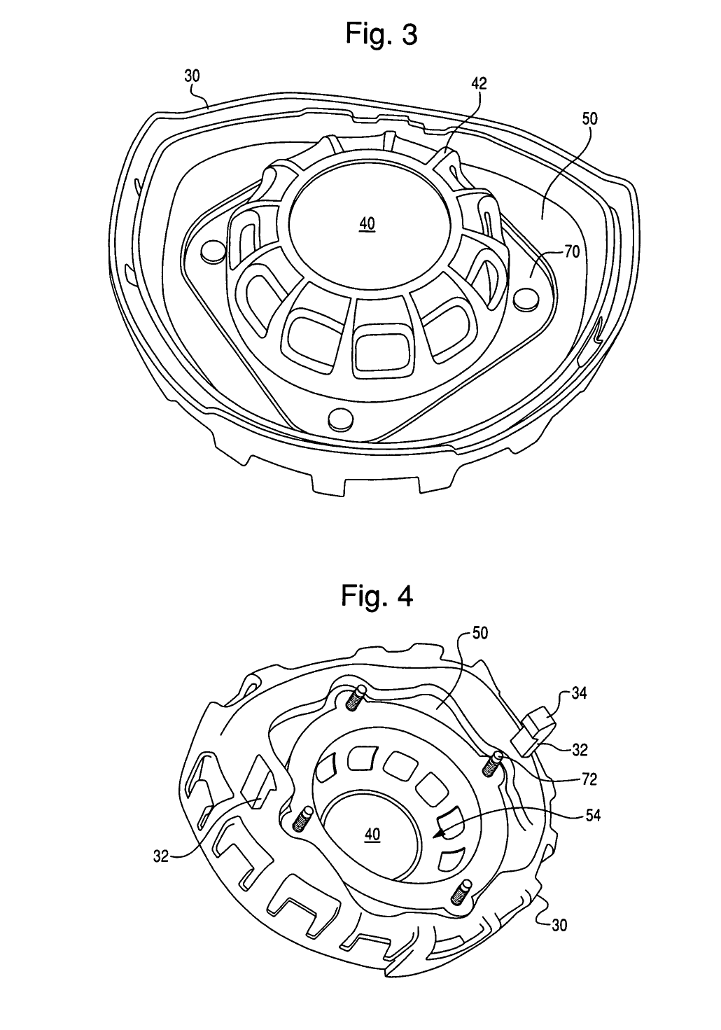

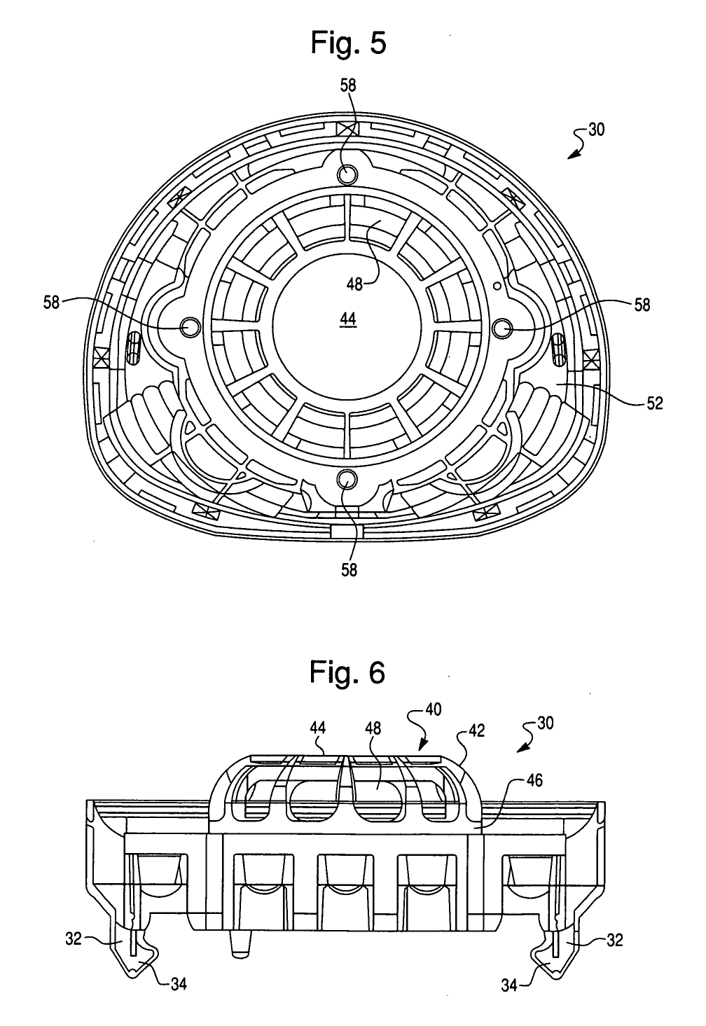

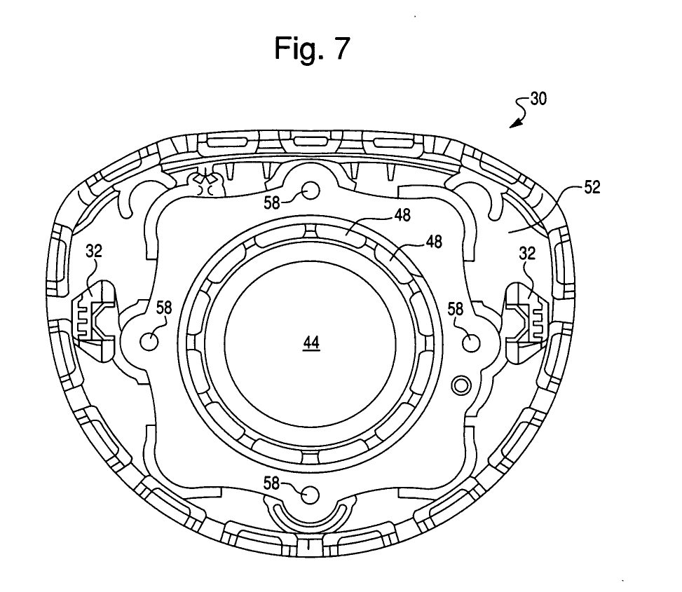

Referring in general to FIGS. 1-7, a portion of a steering wheel airbag module or assembly 20 is shown according to an exemplary embodiment. The airbag module 20 includes an inflator 22, an integrated one-piece retainer and diffuser component (referred hereafter as integrated component 30), an airbag or cushion 60, and an airbag retaining ring 70. Air bag module 20 does not require threaded studs and nuts or other separate components to couple it to vehicle 10. Instead, integrated component 30 couples the airbag assembly to cover 16 and/or steering wheel 12 with two more clips or latches 32. The integrally formed clips 32 include enlarged or barbed heads 34 that are received by retaining sockets (not shown) provided on steering wheel 12 and/or cover 16. The clips 32 can snap into the receiving sockets on the cover 16 and/or steering wheel 12. Alternatively, the integrated component 30 can couple to the cover 16 and/or steering wheel 12 by any suitable mechanism, such as by rivets, screws, glue, etc. Integrated component 30 further includes an integrally formed diffusing section 40 and a retaining section 50.

Inflator 22 may be similar to inflator 122 of FIG. 8 and is a generally cylindrical body that includes outwardly extending flanges. According to an exemplary embodiment, the inflator includes four flanges that are spaced symmetrically about the periphery of the inflator. Alternatively, the inflator 22 can have a single rectangular flange, or any other number, shape or size of flanges. Inflator includes plugs on the back that are configured to be coupled to a sensor (not shown) that activates airbag module 20.

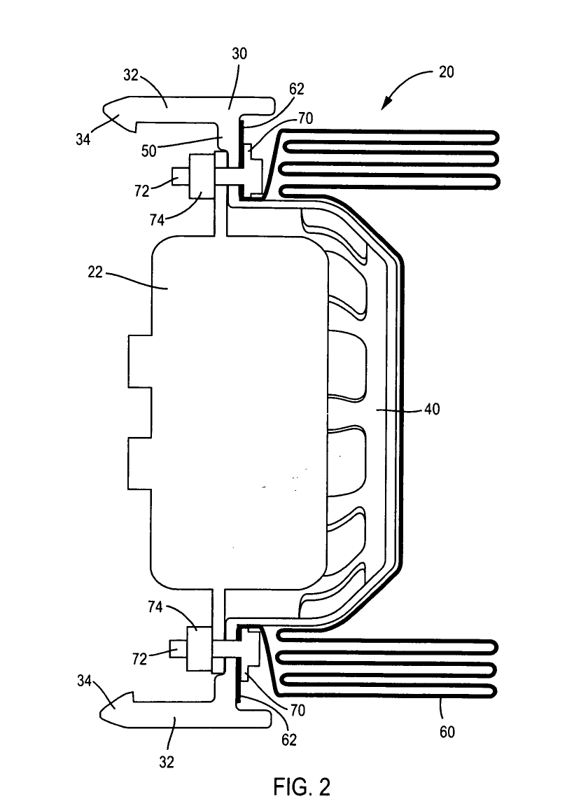

Diffusing section 40 includes a cup-shaped dome portion 42 with an end wall 44 and a skirt 46 that forms one or more openings 48. Diffusing section 40 may be shaped similar to inflator 22 such that inflator 22 nests at least partially within diffusing section 40. Openings 48 allow the gas produced by inflator 22 to expand in multiple directions into the airbag. According to various exemplary embodiments, openings 48 may be larger or smaller and more or fewer openings may be provided in diffusing section 40 as shown in FIGS. 2-7. Diffusing section 40 may further include ribs or other strengthening features to add rigidity and strength to diffusing section 40.

Retaining section 50 is a generally annular body that is integrally formed with diffusing section 40 and generally forms the main body of integrated component 30. Retaining section 50 includes base wall 52 that forms a large central opening 54 (FIG. 4) that receives inflator 22. Opening 54 is aligned with diffusing section 40 so that at least a portion of inflator 22 may be received by diffusing section 40.

As shown best in FIG. 2, airbag cushion 60 is coupled to integrated component 30 with an airbag retaining ring 70. The edges 62 of airbag cushion 60 include multiple openings (not shown). The openings are configured to receive studs 72 that extend from airbag retaining ring 70. Studs 72 also further extend through corresponding openings 58 in retainer section 50 and through openings 24 in inflator 22. The ends of studs 72 are threaded and configured to receive nuts 76. As nuts 76 are tightened, edges 62 of cushion 60, are trapped against retainer section 50. Airbag cushion 60 may be folded in airbag module 20 in a Petri-type fold, or any other suitable fold. In an embodiment, airbag cushion 60 may be folded in airbag module 20 such that only a single layer of airbag fabric is stretched/positioned across diffusing section 40 and/or retaining section 50. Alternatively, the airbag cushion 60 may be folded such that a plurality of layers of airbag fabric are positioned across the diffusing section 40 and/or retaining section 50.

According to one exemplary embodiment, integrated component 30 is formed from a glass-filled polymer composite. Glass fibers are introduced into the plastic, such as nylon, during an injection molding process. In one embodiment, the glass filled plastic material may be, for example, Zytel, or any other suitable type of plastic material.

In one embodiment, the plastic material comprises a range of 10% to 70% glass. In a preferred embodiment, the plastic material comprises a range of 10% to 60% glass. Alternatively, the plastic material comprises a range of 10% to 50% glass. In a particularly preferred embodiment, the glass filled plastic material comprises 40% glass. For example, the material may be 40% glass reinforced nylon PA 6. In yet another embodiment, the plastic material comprises a range of 10% or higher of glass. In yet another embodiment, the plastic material comprises a range of 10% to 30% glass. According to still other exemplary embodiments, the integrated component 30 may be formed from another comparable composite material.

Alternatively, the integrated component 30 may comprise a non plastic material, such as an aluminum alloy or magnesium alloy. The aluminum or magnesium alloys may be die cast to form the integrated component 30. In yet another embodiment, the integrated component 30 may be formed by a stamping process.

Conventionally, plastic was not considered to be a useful material for the diffuser. Generally, a plastic diffuser was not used because the plastic was considered to be likely to fracture due to the hot inflation gases. However, integrated component 30 does not fracture and is able to withstand the hot inflation gases from the inflator.

The diffusing section 40 formed from the composite is lighter than the comparable metal diffuser of FIG. 8. Further, as shown in FIGS. 2-7, the retainer and diffuser are integrated together into a single integrated component 30. Thus, the integrated diffuser and retainer component 30 may have improved strength over the conventional retainer and diffuser while having less manufacturing costs. Additionally, according to some embodiments, by using the integrated component 30 described above, no nut or fastener is needed to attach the diffuser to the retainer and/or the retainer to the airbag module.

Yet another advantage of integrated component 30 is that adjustments may be made to integrated component 30 quickly, efficiently, and inexpensively by making only slight adjustments to the tooling process. For example, the size, position, and type of diffuser openings can be changed easily, quickly, and inexpensively depending on the desired inflation results. Conventionally, changing the design of the metal diffuser was costly and time consuming.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

The construction and arrangement of the elements of the airbag assembly as shown in the preferred and other exemplary embodiments is illustrative only. Although only a few embodiments of the present airbag assembly have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, orientations, etc.) without materially departing from the novel teachings and advantages of the subject matter recited in this disclosure. Accordingly, all such modifications attainable by one versed in the art from the present disclosure within the scope and spirit of the present invention are to be included as further embodiments of the present invention. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present application.

What is claimed is:

1. An airbag retainer integrally combined with a diffuser, the integrated retainer and diffuser being one piece and comprising glass filled plastic.

2. An airbag module, comprising:
an airbag cushion;
a cover;
an inflator to inflate the airbag cushion;
an integrated retainer and diffuser component, the integrated retainer and diffuser component couples to the cover to form a space for the airbag cushion, and wherein the integrated retainer and diffuser component disperses inflation gas from the inflator into the airbag cushion; and
a retaining ring to couple the airbag cushion to the integrated retainer and diffuser component.

3. The airbag module of claim 2, wherein the integrated retainer and diffuser component comprises a glass filled plastic material.

4. The airbag module of claim 3, wherein the integrated retainer and diffuser component comprises glass filled nylon.

5. The airbag module of claim 3, wherein the integrated retainer and diffuser component comprises 40% glass.

6. The airbag module of claim 3, wherein the integrated retainer and diffuser component comprises at least 10% glass.

7. The airbag module of claim 3, wherein the integrated retainer and diffuser component comprises 10% to 70% of glass.

8. The airbag module of claim 3, wherein the integrated retainer and diffuser component comprises 10% to 50% of glass.

9. The airbag module of claim 3, wherein the integrated retainer and diffuser component comprises 10% to 30% of glass.

10. The airbag module of claim 2, wherein the integrated retainer and diffuser component comprises an aluminum alloy.

11. The airbag module of claim 10, wherein the integrated retainer and diffuser component comprises a magnesium alloy.

12. The airbag module of claim 2, wherein the integrated retainer and diffuser component includes retaining section with a base wall and a diffusing section that comprises a dome portion with a front wall and a depending skirt connecting to the base wall, the depending skit comprising at least one opening to allow gas from the inflator to enter the airbag cushion.

13. The airbag module of claim 12, wherein an airbag retaining ring connects to the integrated retainer and diffuser component at the base wall and surrounds the dome portion.
